(19) United States
(12) Patent Application Publication
(10) Pub. No.: US 2007/0175498 A1
(43) Pub. Date: Aug. 2, 2007

(54) Method of washing wheels of a vehicle and apparatus therefor

(75) Inventor: Jim Smith, Nashville, TN (US)

Correspondence Address: SENNIGER POWERS, ONE METROPOLITAN SQUARE, 16TH FLOOR, ST LOUIS, MO, 63102, US

(73) Assignee: D & S CAR WASH SYSTEMS, High Ridge, MO (US)

(21) Appl. No.: 11/668,818

(22) Filed: Jan. 30, 2007

Related U.S. Application Data
(60) Provisional application No. 60/763,651, filed on Jan. 31, 2006.

(51) Int. Cl. B08B 3/00; B08B 3/12

(52) U.S. Cl. 134/34; 134/123; 134/172; 134/198; 134/103.2

(57) ABSTRACT

A method of washing a vehicle and apparatus therefore is disclosed. In one aspect, a wheel washing apparatus is pivotable about a vertical axis. In another aspect, wheels of the vehicle are applied a selective treatment, different from a side of the vehicle.

### BACKGROUND OF INVENTION

The present invention is directed generally to a method of washing wheels of a vehicle and an apparatus therefor.

Some vehicle wash apparatus have a top brush rotatable about a longitudinal axis and having radially extending cloth strands to clean a top surface of a vehicle as the top brush rotates. To ensure a good, quality cleaning of the top surface, the cloth strands should closely profile the surface, although too much contact may damage the surface of the vehicle. One type of conventional apparatus uses a counterweight to help the top brush properly profile the top surface of the vehicle. However, during installation, the counterweight has to be adjusted (such as moving the weight closer to or further from the top brush) and tested on a vehicle to ensure that the top brush is properly profiling the vehicle. Moreover, during the operational life of the apparatus, the effect of the counterweight may diminish (due to wear of the various components) and the counterweight will have to be periodically readjusted. Moreover still, the effect of the counterweight may be different, and not as effective, for different types of vehicles, such as larger trucks and SUVs.

Conventional vehicle wash apparatus also used chains and toothed gears for vertically moving the top brush. The chains and gears are not well suited for the car washing environment, as water, detergent and other debris and chemicals may affect the performance of the chains and gears. For example, debris may become lodged in a gear, or links in the chain may rust or otherwise stiffen. Thus, apparatus with chains and gears may have to be periodically maintenance to ensure that the chains and gears are well lubricated and that debris is not hindering performance.

In some conventional car washing apparatus, the apparatus includes a wheel washer for washing wheels of the vehicle. Typically, the wheel washer applies a high pressure liquid (such as water) to the wheels in a direction generally perpendicular to an outer face of the tire. Thus, typically only the front face of the wheel, and not the wheel wells, are being cleaned. Moreover, the wheels are only being contacted with liquid at a 90 degree angle, which may not be effective at removing hard-to-remove dirt and oil.

Also, in some conventional car washing apparatus, wheel-specific treatment, such as wheel-specific cleaner, is applied not only to the wheels, but also to the entire side of the vehicle, including the rocker panels and the doors. This is an inefficient method of applying wheel cleaner that is wasteful of wheel cleaning treatment.

### SUMMARY OF INVENTION

In one embodiment, a method of washing a vehicle comprises providing a spray apparatus including an elongate spray bar comprising a plurality of nozzles for directing liquid toward the vehicle. The spray bar is rotatable about a generally horizontal rotational axis. The spray bar of the spray apparatus is disposed adjacent a wheel of the vehicle such that the spray apparatus is in a first position. The spray bar is rotated about its rotational axis. The spray apparatus is pivoted about a generally vertical pivotal axis in a first direction from the first position to a second position. Fluid is directed out of the nozzles towards the wheel of the vehicle.

In another embodiment, a wheel washing apparatus for washing wheels of a vehicle comprises a spray device including an elongate spray bar having nozzles disposed along its length bar for directing streams of fluid from the bar, and a rotational device for rotating the spray bar about a generally horizontal rotational axis. A pivoting device pivots the spray device about a generally vertical pivotal axis in a first direction between a first position and a second position.

In yet another embodiment, a method of washing wheels of a vehicle, comprises advancing the spray bar along the length of the vehicle, and applying a treatment of a first type to a side of the vehicle as the spray bar advances along the length of the vehicle. The advancement of the spray bar along the length of the vehicle is temporarily stopped at a first wheel. A treatment of a second, different type is applied to the wheel of the vehicle using the same spray bar when the advancement of the spray bar has been stopped. Advancement of the spray bar along the length of the vehicle is continued after application of the treatment to the wheel.

Other objects and features will be in part apparent and in part pointed out hereinafter.

### BRIEF DESCRIPTION OF THE DRAWINGS

FIG. 1 is a perspective of a vehicle washing apparatus, including a carriage and a top brush;

FIG. 2 is a hydraulic schematic of a hydraulic circuit for operating carriage motors;

FIG. 3 is an enlarged perspective of the carriage and top brush of the vehicle washing apparatus;

FIG. 4 is a left elevational view of the top brush of FIG. 3;

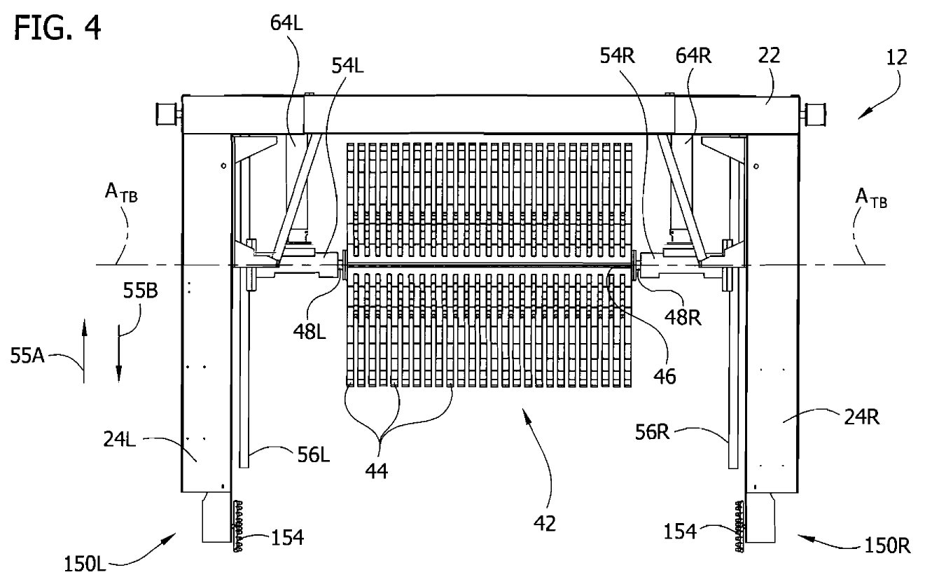

FIG. 5 is a schematic of a lift system including a lift cylinder for vertically moving the top brush of the vehicle washing apparatus;

FIG. 6 is a hydraulic schematic of a hydraulic circuit for operating the lift cylinder of the lift system of FIG. 5;

FIG. 7 is a hydraulic schematic of the hydraulic circuit of FIG. 6 operating to retract a rod of the hydraulic cylinder of the lift system;

FIG. 7A is a schematic of the lift system of FIG. 5 operating to lift the top brush;

FIG. 8 is a hydraulic schematic of the hydraulic circuit of FIG. 6 operating to extend the rod of the hydraulic cylinder of the lift system;

FIG. 8A is a schematic of the lift system of FIG. 5 operating to lower the top brush;

FIG. 9 is the hydraulic schematic of if the hydraulic circuit of FIG. 6 operating to completely retract the rod of the hydraulic cylinder using an accumulator;

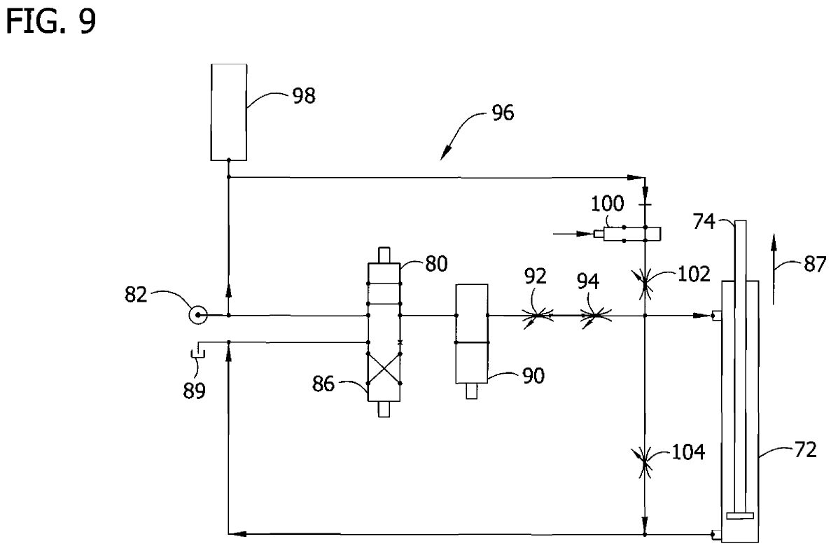

FIG. 10 is a schematic of a speed detector for detecting rotational speed of the top brush;

FIG. 10A is a schematic of a lift/lower range and a stop range for a rotational speed monitoring feature of the apparatus;

FIG. 11 is a flow chart of instructions for a controller of the vehicle washing apparatus to determine when the top brush should be lifted and lowered and when the carriage should be stopped;

FIG. 12 is a schematic illustrating relevant input and output signals for moving the top brush vertically and longitudinally;

FIG. 13 is a flow chart of instructions for the controller to determine lift/lower and stop ranges;

FIG. 14 is an enlarged perspective of a wheel washing apparatus of the car washing apparatus;

FIG. 15 is a schematic of the wheel washing apparatus;

FIG. 16A is a pneumatic schematic of a pneumatic circuit for extending and retracting a rod of an pneumatic cylinder of a pivotal device;

FIG. 16B is a pneumatic schematic of the pneumatic circuit of FIG. 16A operating to extend the rod;

FIG. 16C is a pneumatic schematic of the pneumatic circuit of FIG. 16A operating to retract the rod;

FIG. 17A is a schematic of the wheel washing apparatus with the spray device being in a first position;

FIG. 17B is a schematic of the wheel washing apparatus with the spray device being in a second position; and

FIG. 17C is a schematic of the wheel washing apparatus with the spray device being in a third position;

Corresponding reference characters indicate corresponding parts throughout the drawings.

### DETAILED DESCRIPTION OF THE DRAWINGS

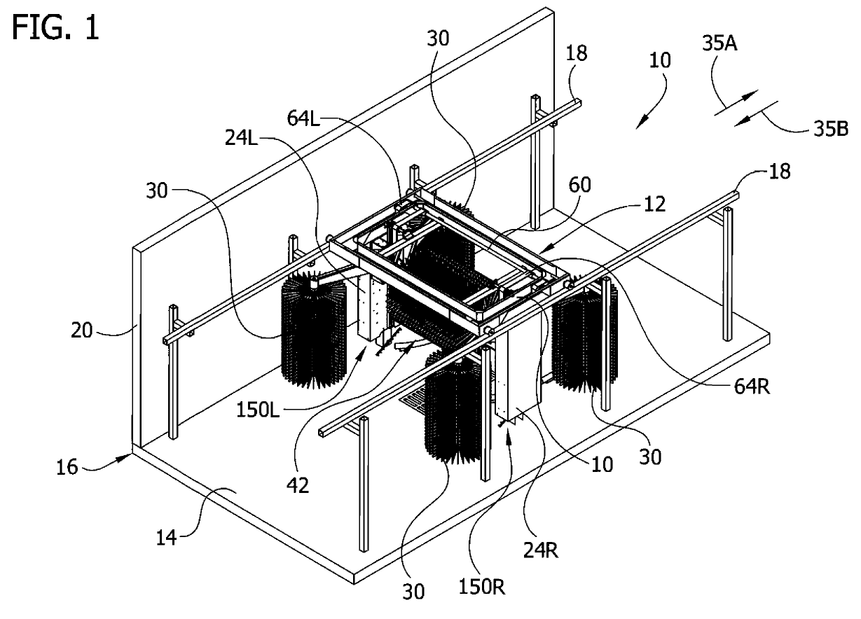

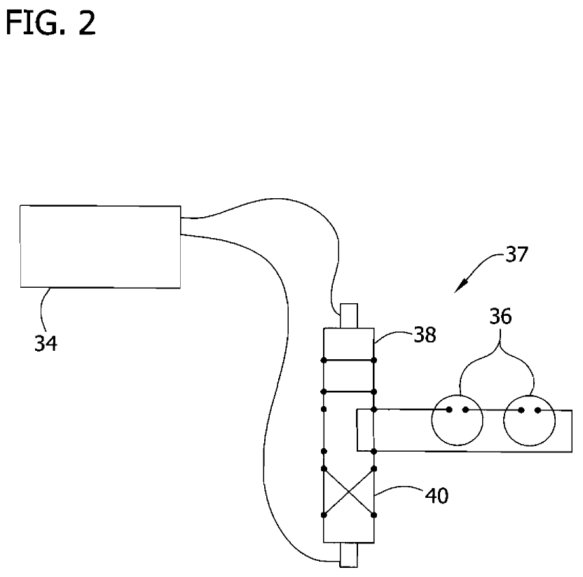

Referring now to the drawings, and in particular to FIG. 1, a car wash apparatus is generally indicated at reference numeral 10. The car wash apparatus 10 comprises a carriage, generally indicated at 12, suspended above a floor 14 of a bay 16 and mounted on a pair of spaced apart, generally horizontal rails 18 secured to walls 20 of the bay. (For illustrative purposes, only one wall is shown in FIG. 1.) The carriage 12 includes a rectangular top bracket 22 moveable on the rails 18 at its opposite ends and a pair of spaced apart right and left legs 24L, 24R, respectively, extending down from the top bracket to define an opening for receiving a vehicle therein. The carriage 12 includes conventional high pressure nozzles (not shown), foaming shower heads (not shown), and side brushes 30 rotatable about a generally vertical axis. The construction and function of the high pressure nozzles, shower heads and side brushes 30 are generally known in the art and will not be described in detail herein. The car wash apparatus 10 also includes a treadle (not shown) disposed on the floor 14 of the bay 16 for receiving a front wheel of the vehicle. Reception of the front wheel in the treadle actuates a wash cycle of the washing apparatus 10. The operation of the apparatus 10, including the operation of its various components and devices, may be automated and controlled by a controller 34 (FIGS. 2, 6, 10 and 12), such as a microcontroller.

The entire carriage 12 is longitudinally moveable in opposite forward and rearward directions 35A, 35B, respectively, on the rails 18 by at least one carriage motor 36 (e.g., a hydraulic motor) illustrated schematically in FIG. 2, which includes an exemplary hydraulic circuit, generally indicated at 37, for driving the carriage motors is illustrated. The circuit includes a forward carriage valve 38 (e.g., a solenoid valve) and a rearward carriage valve 40 (e.g., a solenoid valve) that may be opened and closed by the controller 34. To actuate forward and rearward longitudinal movement of the carriage 12, the controller 34 opens the corresponding forward carriage valve 38 and rearward carriage valve 40.

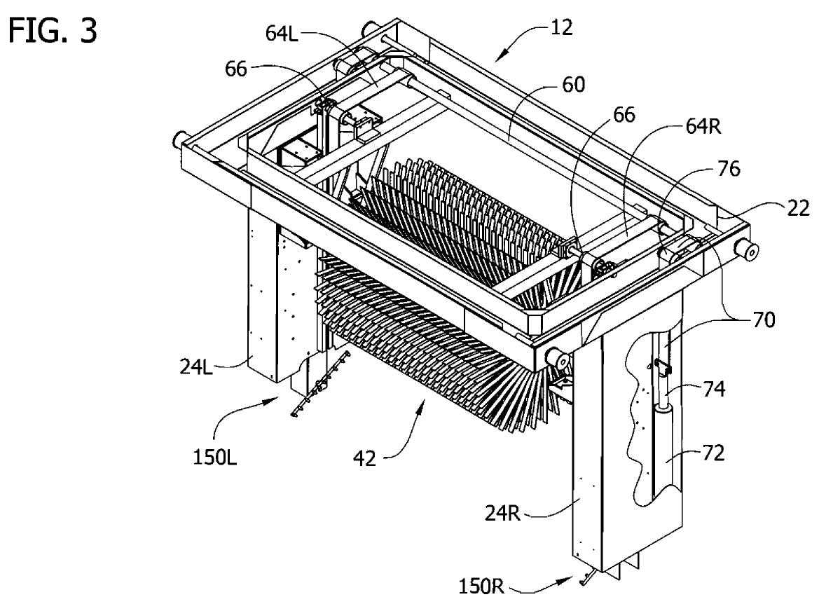

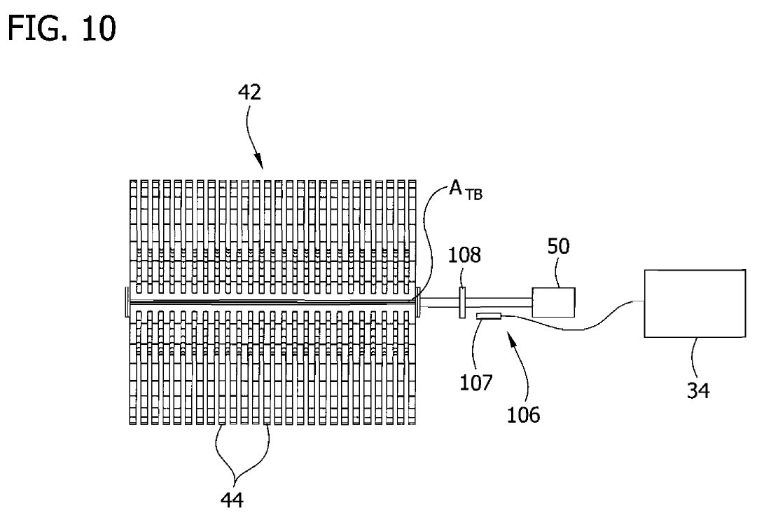

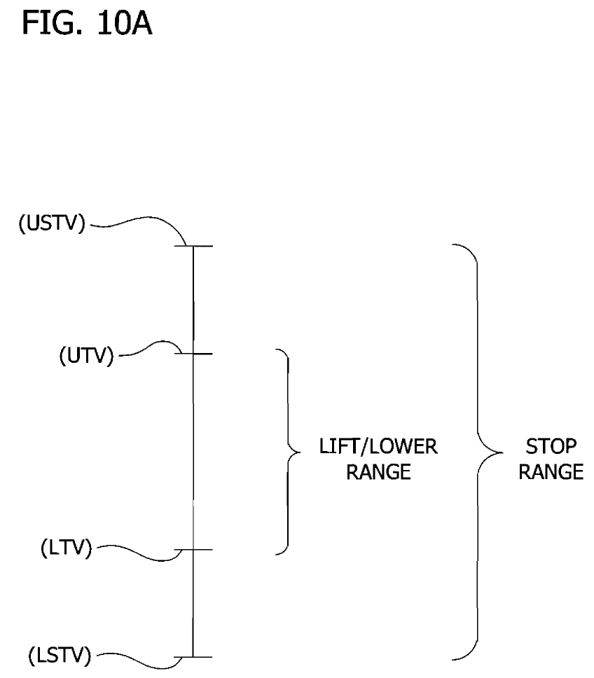

Referring to FIGS. 1-3, a top brush, generally indicated at 42, mounted on the carriage 12 extends generally horizontally between the legs 24L, 24R of the carriage and is longitudinally movable with the carriage. The top brush 42 includes a longitudinal axis A_{TB} and radially extending cloth strands 44 for contacting and cleaning an upper surface of the vehicle. The top brush 42 is rotatable about a brush axle 46 having a left end margin 48L and a right end margin 48R and being generally coaxial with the longitudinal axis A_{TB} of the brush. At least one of the end margins 48L, 48R of the brush axle 46 engages a brush motor 50 (e.g., a hydraulic motor), schematically illustrated in FIG. 10, for rotating the top brush 42. The motor 50 may be configured to rotate the top brush 42 in rearward and forward directions 35A, 35B, and therefore it may have separate forward and rearward hydraulic lines (not shown) for rotating the brush forward and rearward, respectively. The construction and operation of the motor is well known in the art and will not be described in detail herein. At least a portion of each of the left and right end margins 48L, 48R of the brush axle 46, including the brush motor 50, is encased in a corresponding left and right brush-axle casings 54L, 54R (FIG. 3). The top brush 42 may be rotationally driven in other ways without departing from the scope of this invention.

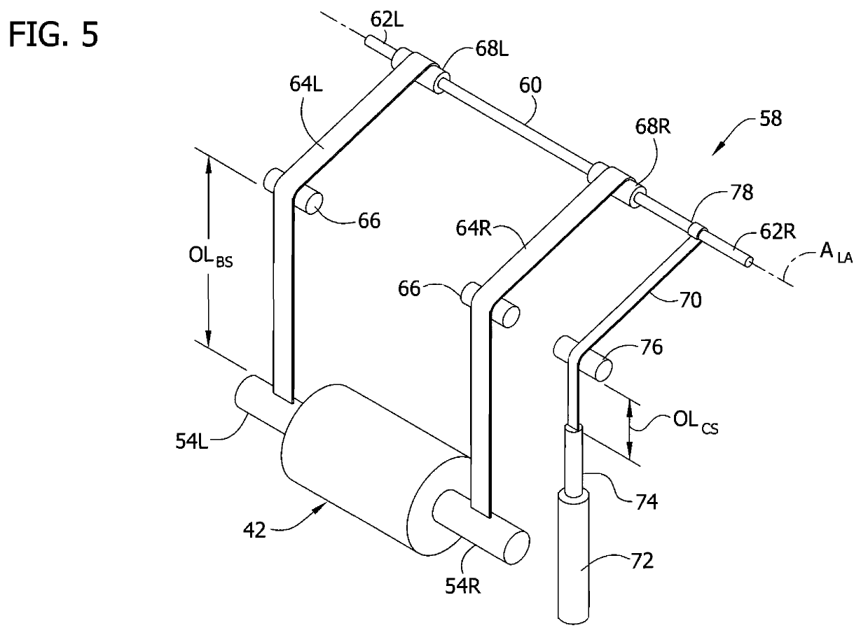

The top brush 42 is movable vertically (i.e., in an upward direction 55A and a downward direction 55B) within tracks 56L, 56R running vertically along the corresponding left and right legs 24L, 24R of the carriage 12. As shown best in FIG. 3, each brush-axle casing 54L, 54R is slidably received on the corresponding track 56L, 56R. Referring to FIGS. 3 and 5, a lift system, generally indicated at 58, is operable to vertically move (i.e., lift in the upward direction 55A and lower in the downward direction 55B) the top brush 42 in the tracks 56L, 56R. The lift system 58 includes a lift axle 60 secured to the top bracket 22 of the carriage 12 and having respective left and right end margins 62L, 62R.

The lift system 58 also includes left and right pliable, elongate brush straps 64L, 64R, respectively. Each strap 64L, 64R has a first end margin secured to an adjacent, corresponding brush-axle casing 54L, 54R and a second end secured to the lift axle 60 at a corresponding end margin 62L, 62R. Each brush strap 64L, 64R extends upward from the brush-axle casing 54L, 54R and extends around a first stationary roller 66 to the lift axle 60. Each brush strap 64L, 64R is wound around the lift axle 60 at a respective first wind location 68L, 68R, such that an operative length OL_{BS} of the brush straps 64L, 64R extending between the brush-axle casings 54L, 54R and the first rollers 66 may be lengthened and shortened by rotating the lift axle in different directions about a longitudinal axis A_{LA} of the lift axle. As explained in more detail below, in the illustrated embodiment, lengthening the operative length OL_{BS} of the brush straps 64L, 64R lowers the top brush 42 while shortening the operative length of the brush straps lifts the top brush.

Referring still to FIGS. 3 and 5, the lift system 58 also includes a pliable, elongate cylinder strap 70 and a lift cylinder 72 (e.g., a single-acting hydraulic cylinder) for driving rotation of the lift axle 60 about its longitudinal axis A_{LA}. The cylinder strap 70 has a first end margin connected to a lift rod 74 of the lift cylinder 72 and a second end margin connected to the lift axle 60. The cylinder strap 70 extends from the lift rod 74 around a stationary roller 76 to the lift axle 60. The second end margin of the cylinder strap 70 is wound around the lift axle 60 at a second wind location 78, such that an operative length OL_{CS} of the cylinder strap extending between the rod and the second stationary roller 76 may be lengthened and shortened by rotating the lift axle in different directions about the longitudinal axis A_{LA} of the lift axle.

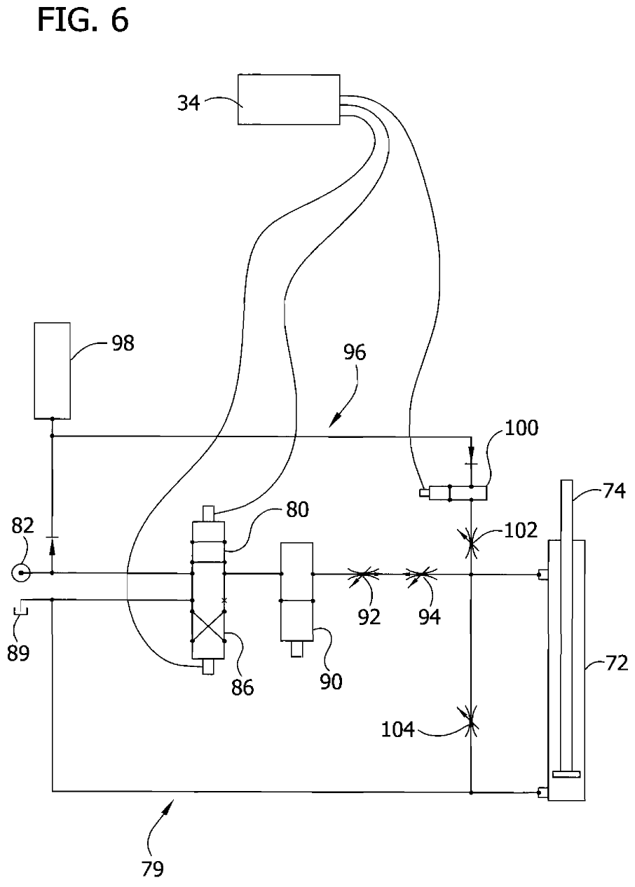

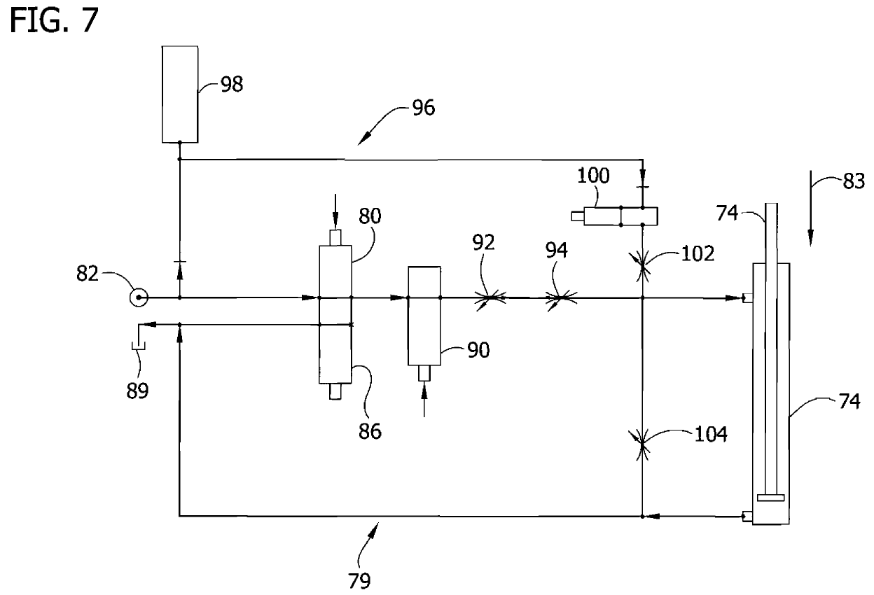

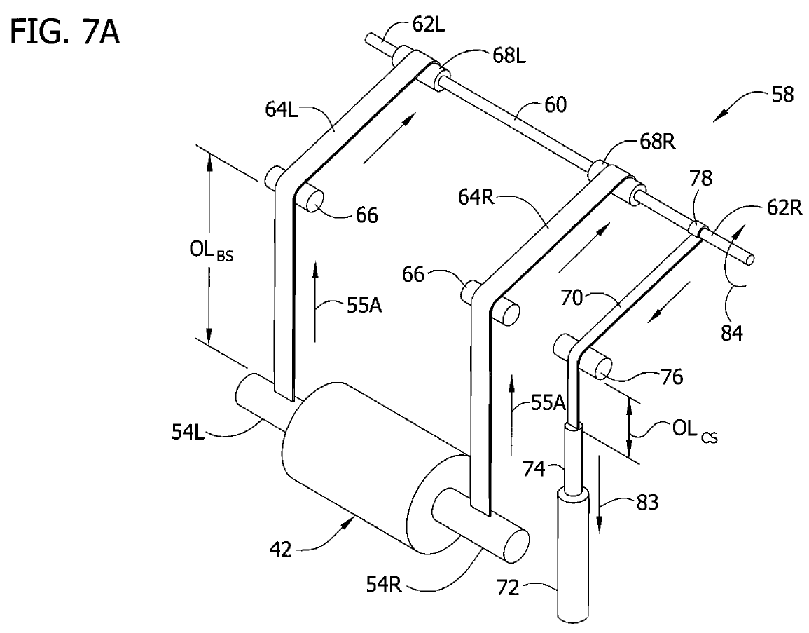

In the illustrated embodiment, movement of the lift rod 74 controls rotational movement of the lift axle 60. An exemplary hydraulic circuit, generally indicated at 79, for operating the hydraulic lift cylinder 72 is illustrated schematically in FIG. 6. A lift valve 80, such as a solenoid valve illustrated, fluidly connects the lift cylinder 72 to a source of hydraulic pressure 82. The controller 34 actuates opening of the lift valve 80, the lift valve being normally closed (i.e., biased in a closed position). As illustrated schematically in FIG. 7, opening the lift valve 80 pressurizes the lift cylinder 72 and forces retraction of the lift rod 74 (i.e., forces the lift rod in a downward direction 83). As illustrated in FIG. 7A, the forced retraction of the lift rod 74 unwinds the cylinder strap 70 (i.e., lengthens the operative length OL_{CS} of the cylinder strap), thereby rotating the lift axle 60 in a first direction 84. Rotation of the lift axle 60 in the first direction 84 further winds the brush straps 64L, 64R around the lift axle, shortening the operative length OL_{BS} of the brush straps and lifting the top brush 42.

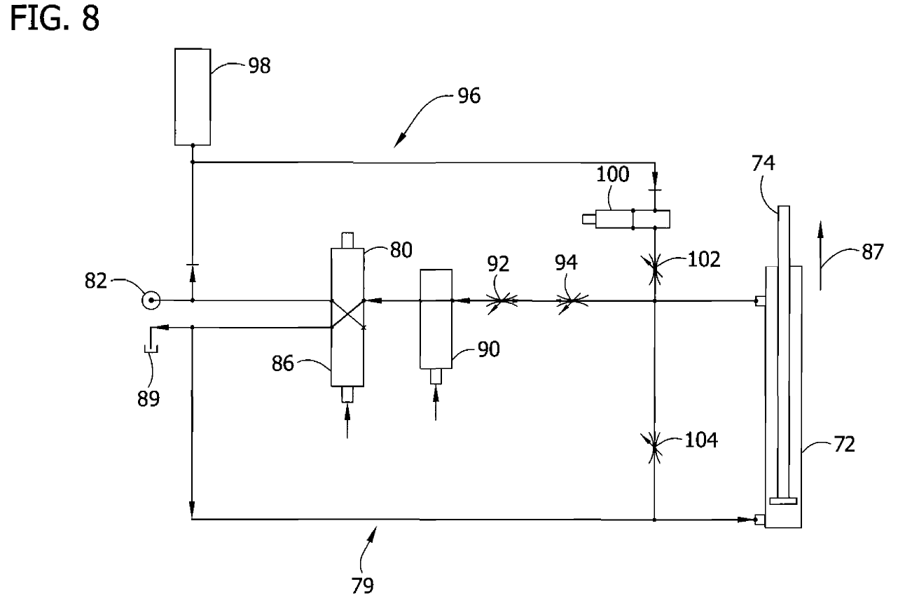

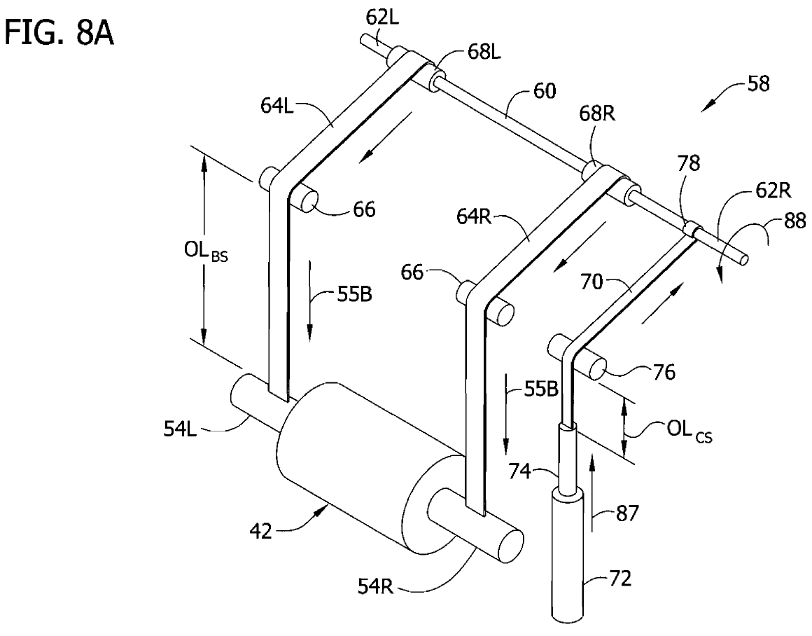

Referring back to FIG. 6, a lift bleed valve 86, such as a solenoid valve, is fluidly connected to the lift cylinder 72 to relieve pressure from the cylinder to allow the lift rod 74 to passively extend (i.e., move in an upward direction 87). The released pressure is redirected to a reserve tank 89. The controller 34 actuates opening of the bleed valve 86, the bleed valve being normally closed (i.e., biased in a closed position). As illustrated in FIG. 8, to allow the top brush 42 to lower, the lift valve 80 is closed and the lift bleed valve 86 is opened to relieve pressure within the cylinder 72. As illustrated schematically in FIG. 8A, as the hydraulic pressure is being relieved from the lift cylinder 72, the weight of the top brush 42 unwinds the brush straps 64L, 64R around the lift axle 60 (i.e., lengthens the operative length OL_{BS} of the brush straps) and rotates the lift axle in a second direction 88. Rotation of the lift axle 60 in the second direction 88 winds the cylinder strap 70 around the lift axle (i.e., shortening the operative length OL_{CS} of the cylinder strap) and extends the lift rod 74 out of the cylinder 72.

The hydraulic circuit 79 illustrated in FIG. 6 also includes a counter-balance valve 90 for locking in the hydraulic pressure in the cylinder 72 to prevent backflow of pressure from the cylinder causing the top brush 42 to unintentionally slide downward. The counter-balance valve 90 is normally closed (i.e., biased in the closed position), and is open when either the lift valve 80 or the bleed valve 86 is open. The hydraulic circuit 79 further includes a lift speed-adjust valve 92 and a lower speed-adjust valve 94. These valves 92, 94 function to control the speed at which the top brush 42 is lifted and lowered, respectively, when the respective lift and bleed valves 80, 86, respectively, are open.

It is understood that the lift system 58 may be configured in other ways. There may be other valves associated with the lift system 58, and the hydraulic circuit may be configured in other ways without departing from the scope of this invention. For example, the lift system 58 may be configured such that forced extension of the rod 74 lifts the top brush 42 and passive retraction of the rod lowers the top brush. Moreover, other types of cylinders, besides single-acting hydraulic cylinders, are contemplated. For example, a double-acting cylinder (acting to both retract and extend the rod) can be used. The cylinder may be of other types and may be configured in other ways without departing from the scope of this invention.

Referring back to FIG. 6, in one embodiment, the vehicle washing apparatus 10 also includes a safety mechanism, generally indicated at 96, for the top brush 42 that extends the top brush in an upper position (e.g., an uppermost position) when the top brush is not operating (i.e., when the controller is not operating the brush) and/or if there is a malfunction with the apparatus, such as a loss of power. In the illustrated embodiment, the safety mechanism 96 comprises an accumulator 98 (e.g., a hydraulic accumulator) fluidly connected to the cylinder 72 of the lift system 58 via an accumulator valve 100, such as a solenoid valve. The accumulator 98 may be of various types.

Referring still to FIG. 6, the controller 34 controls the operation of the accumulator valve 100. In one example, the accumulator valve 100 is normally (i.e., biased) in an open position. When the controller 34 is operating the top brush 42, the controller maintains the accumulator valve 100 closed, such that the accumulator 98 is not fluidly connected to and is not pressurizing the lift cylinder 72. When the controller 34 is not operating the top brush 42, e.g., when the washing apparatus is idle or when there is a loss of power, the accumulator valve 100 will automatically open because the controller is not keeping it open. Opening the accumulator valve 100 allows hydraulic pressure from the accumulator 98 to fully pressurize the lift cylinder 72 and fully retract the lift rod 74, thereby lifting of the top brush 42 to or near its upper position. The accumulator valve 100 remains open, and the lift cylinder 72 fully pressurized, until the controller 34 closes the valve. Other configurations of the accumulator valve and the controller as part of the safety mechanism are within the scope of this invention.

The safety mechanism 96 may also comprise an accumulator adjust valve 102 and an accumulator dump valve 104. The accumulator adjust valve 102 operates to control the speed at which the lift rod 74 retracts and the top brush lifts 42. The adjust valve 102 also allows a mechanic to isolate the accumulator 98 from the lift cylinder 72 to bypass the safety mechanism 96. This may be employed, for example, when maintenance needs to be done on the top brush 42. The accumulator dump valve 104 also operates to allow a mechanic to perform work on the top brush 42. Opening the dump valve 104 directs (i.e., dumps) the hydraulic fluid in the pressurized accumulator 98 into the reserve tank 89. Other features, including valves and other components, are within the scope of this invention.

In one embodiment, the controller 34 is configured to ensure that the cloth strands 44 of the top brush 42 substantially continuously contact the upper surface of the vehicle with the same amount of force as the brush moves longitudinally along the top surface of the vehicle. The controller 34 both monitors the position of the top brush 42 relative to the vehicle as the washing apparatus 10 is operating and controls both the longitudinal and vertical movements of the top brush in response to the monitored position of the top brush.

To monitor the vertical and longitudinal positions of the top brush 42 relative to the vehicle, a parameter indicative of rotation of the top brush is monitored as the cloth strands 44 of the rotating top brush contact the vehicle. Referring to FIG. 10, in one embodiment, the parameter monitored is the rotational speed of the top brush 42. A speed detector, generally indicated at 106, detects the rotational speed of the top brush 42 as its contacts the vehicle. For example, the speed detector 106 may comprise a proximity detector 107 and a toothed detecting wheel 108 coaxially secured to the brush axle 46. The proximity detector 107 is secured a fixed distance from the detecting wheel 108. As the top brush 42 and the coaxial detecting wheel 108 rotate adjacent the proximity detector 107, the proximity detector detects when a tooth of the wheel passes by it. The proximity detector 107 sends a signal (e.g., a pulse signal) to the controller 34 every time a tooth of the detecting wheel 108 passes. The controller 34 calculates the rotational speed of the top brush 42 by determining the elapsed time between a fixed number of signals received from the proximity detector 107 (e.g., the time between five consecutive pulses). Other ways of detecting the speed of the top brush 42 is within the scope of this invention.

This embodiment of detecting the rotational speed of the top brush 42 to monitor the position of the top brush relative to the vehicle is predicated on the knowledge that when the rotating top brush moves closer to the surface of the vehicle and a greater surface area of the cloth strands 44 contact the surface of the vehicle, the rotational speed of the top brush decreases. Conversely, when the rotating top brush 42 moves further away from the surface of the vehicle and a lesser surface area of the cloth strands 44 contact the surface of the vehicle, the rotational speed of the top brush increases. Thus, if for example, the rotational speed (RS) of the top brush 42 falls below a first predetermined speed, then it can be determined that the top brush needs to be lifted away from the vehicle. This may occur when the top brush 42 is moving along a portion of the vehicle having a relatively small, inclined slope, such as at a hood of the vehicle when the top brush is moving from the front of the vehicle to its rear. If the rotational speed of the top brush 42 falls below a second predetermined speed that is less than the first predetermined speed, then it can be determined that the top brush not only needs to be lifted, but also the longitudinal movement of the top brush (i.e., the carriage) needs to be stopped to allow the top brush time to lift along the contour of the vehicle. This may occur when the top brush 42 is moving along a portion of the vehicle from having a relatively large, inclined slope, such as at a front end and a windshield of the vehicle when the top brush is moving from the front of the vehicle to its rear.

The converse also holds true; that is, if the rotational speed of the top brush 42 is greater than a third predetermined speed that is greater than the first predetermined speed, then the top brush needs to be lowered to come into more contact with the vehicle. This may occur when the top brush 42 is moving along a portion of the vehicle having a relatively small, declined slope, such as at a trunk of the vehicle when the top brush is moving from the front of the vehicle to its rear. If the rotational speed of the top brush 42 is greater than a fourth predetermined speed that is greater than the third speed, then it can be determined that the top brush not only needs to be lowered, but also the longitudinal movement of the top brush (i.e., the carriage 12) needs to be stopped to allow the top brush 42 time to lower along the contour of the vehicle. This may occur when the top brush 42 is moving along a portion of the vehicle having a relatively large, declined slope, such as at a rear surface of the vehicle when the vehicle is a SUV (sports utility vehicle) and the top brush is moving from the front of the vehicle to its rear.

As referred to above, it is understood that the top brush 42 and the carriage 12 may be configured to apply the top brush to the vehicle not only as the top brush moves from the front of the vehicle to its rear, but also as it moves from the rear of the vehicle to its front. Accordingly, for example, when the top brush 42 is moving from the rear of the vehicle to its front, the rear surface of the SUV, for example, becomes a large, inclined sloping surface. Thus, the carriage 12 must be stopped and the top brush must be lifted.

Moreover, the controller 34 may rotate the top brush 42 in the first, forward direction as the top brush moves from the front of the vehicle to its rear and the controller may rotate the top brush in the second, rearward direction as the top brush moves from the rear of the vehicle to its front. The controller 34 may also change rotational directions again at anytime during longitudinal movement of the top brush 42.

Referring to FIG. 10A, in one embodiment, the controller collects a rotational speed value (RS) of the top brush and compares the value to a lift/lower range and a stop range. The lift/lower range is defined by an upper threshold value (UTV) and a lower threshold value (LTV), and the stop range is defined by an upper stop threshold value (USTV) and lower stop threshold value (LSTV).

Using the example of FIG. 10A, if the rotational speed value (RS) is within the lift/lower range and the stop range, then 1) the vertical position of the top brush 42 should be maintained and 2) the top brush should continue advancing longitudinally. If the rotational speed value (RS) is greater than the lift/lower range, but within the stop range, then 1) the top brush 42 should be lowered and 2) the carriage 12 should continue longitudinal advancement. If the rotational speed value (RS) is greater than both the lift/lower range and the stop range, then 1) the top brush 42 should be lowered and 2) the carriage 12 should be stopped. If the rotational speed value (RS) is less than the lift/lower range, but within the stop range, then 1) the top brush 42 should be lifted and 2) the carriage 12 should continue longitudinal advancement. If the rotational speed value (RS) is less than both the lift/lower range and the stop range, then 1) the top brush 42 should be lifted and 2) the carriage 12 should be stopped.

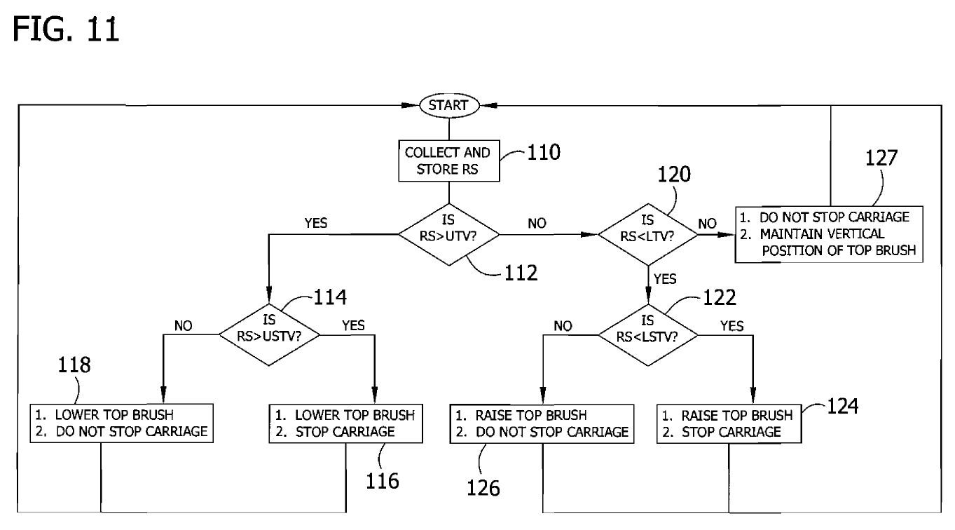

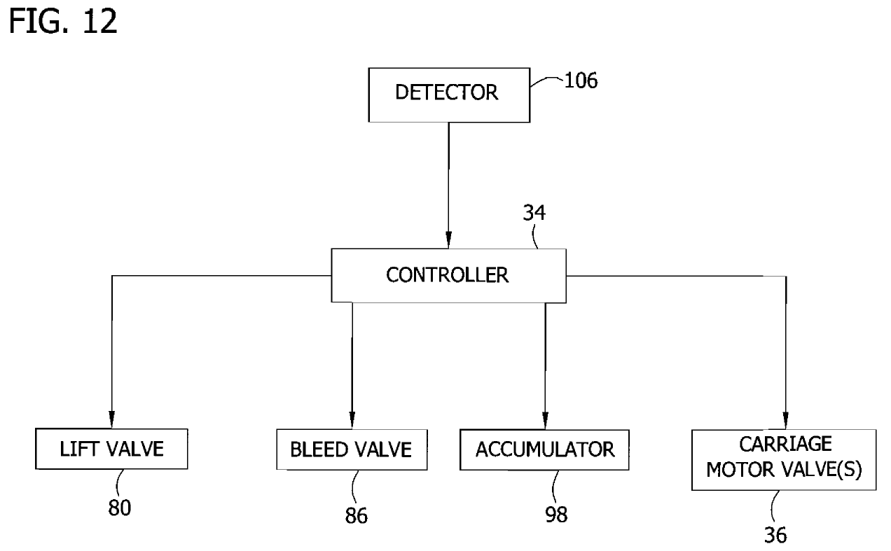

Referring to FIGS. 11 and 12, in one example of monitoring the rotational speed of the top brush 42 using the controller 34, the controller is instructed at 110 to collect and store a rotational speed value (RS) from the input signal received from the proximity detector 107. The controller 34 is then instructed at 112 to determine if the rotational speed value (RS) is greater than the upper lift/lower threshold value (ULTV). If the rotational speed value (RS) is greater than the upper threshold value (UTV) of the lift/lower range, then the controller 34 is instructed at 114 to determine if the rotational speed value (RS) is greater than the upper stop threshold value (USTV). If the rotational speed value (RS) is greater than the upper stop threshold value (USTV), then the controller 34 is instructed at 116 to both 1) lower the top brush 42 (e.g., open the bleed valve 86) and 2) stop the carriage 12 (e.g., close all carriage motor valves 38, 40). If the rotational speed value (RS) is not greater than the upper stop threshold value (USTV), then the controller 34 is instructed at 118 to 1) lower the top brush 42 (e.g., open the bleed valve 86) and 2) continue longitudinal advancement of the carriage 12 and the top brush (e.g., keep the appropriate motor valve 38, 40 open).

Referring back to 112, if the rotational speed value (RS) is not greater than the upper threshold value (UTV) of the lift/lower range, then the controller 34 is instructed at 120 to determine if the rotational speed value (RS) is less than the lower threshold value (LTV) of the lift/lower range. If the rotational speed value (RS) is less than the lower threshold value (LTV) of the lift/lower range, then the controller 34 is instructed at 122 to determine if the rotational speed value (RS) is greater less than the lower stop threshold value (LSTV). If the rotational speed value (RS) is less than the lower stop threshold value (LSTV), then the controller 34 is instructed at 124 to both 1) lift the top brush 42 (e.g., open the lift valve 80) and 2) stop the longitudinal advancement of the carriage 12 (e.g., close the carriage motor valves 38, 40). If the rotational speed value (RS) is not less than the lower stop threshold value (LSTV), then the controller 34 is instructed at 126 to 1) raise the top brush 42 (e.g., open the lift valve 80) and 2) continue longitudinal advancement of the carriage 12 and the top brush (e.g., keep the appropriate carriage motor valve 38, 40 open).

Referring back to 120, if the rotational speed value (RS) is not less than the lower threshold value (LTV) of the lift/lower range, then the controller 34 is instructed at 127 to both 1) continue longitudinal advancement of the carriage 12 and top brush 42 and 2) maintain vertical position of the top brush.

After 116, 118, 124, 126, and 127, the controller 34 is instructed to collect and store another rotational speed value (RS) and perform the same instructions given above. The controller 34 continues to perform these instructions during operation of the top brush 42. During operation of the top brush 42, the controller is maintaining the accumulator valve 100 closed, so that the accumulator 98 is not fluidly connected to the lift cylinder 72. As explained above, when the controller 34 is no longer operating the top brush 42, the accumulator valve 100 is opened and the top brush is fully retracted.

It is understood that the washing apparatus may of a different type of vehicle washing apparatus than the illustrated apparatus. For example, the apparatus may comprise a vertically moveable top brush mounted on a stationary carriage, instead of on a longitudinally moveable carriage. In this example, the vehicle washing apparatus may comprise a conveyor-type device for longitudinally moving the vehicle. Thus, although the top brush itself is stationary, the longitudinal position of the top brush relative to the vehicle advances when the conveyor moves the vehicle. In this example, a controller may still control the vertical movement of the top brush, but instead of also controlling the longitudinal movement of the top brush, the controller controls the longitudinal movement of the vehicle, itself. Thus, instead of stopping the carriage, the controller may stop the conveyor. Besides this difference, this exemplary vehicle washing apparatus would operate in substantially the same way as the illustrated vehicle washing apparatus.

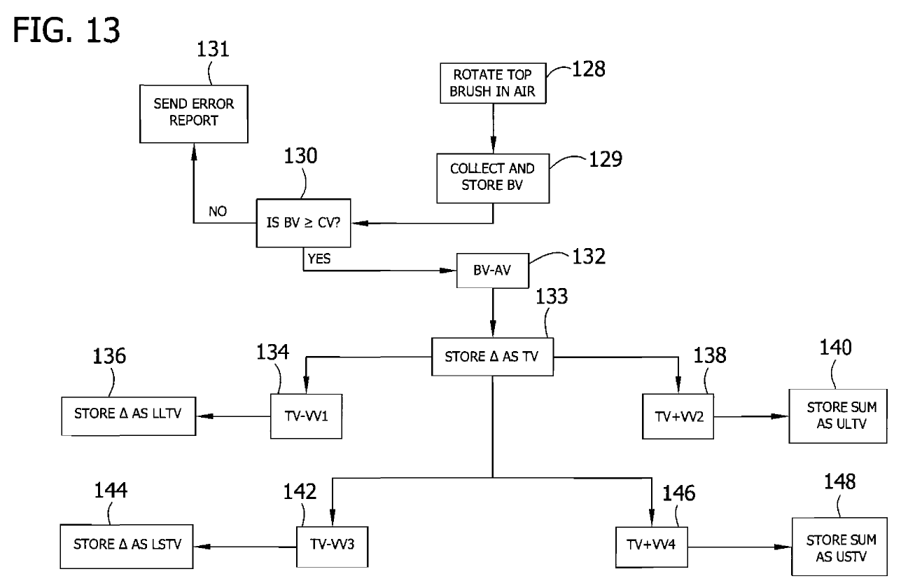

In one embodiment, the lift/lower range and the stop range are determined before each individual wash cycle. In one example illustrated in FIG. 13, the ranges are determined by the controller 34 in the following manner. Before bringing the top brush 42 into contact with the vehicle, the controller 34 is instructed at 128 to rotate the brush in the air, without contacting any surface, e.g., while the brush is in its upper position. The rotational speed of the brush 42 in air is determined, for example, in the manner described above. In one example, the controller 34 monitors the rotational speed of the top brush 42 for between about 5 to about 10 seconds. The controller is instructed at 129 to calculate an average of the rotational speed of the top brush 42 during this time period and store this average as a baseline value (BV) in its memory. For example, the baseline value may be about 105 rpm.

After calculating the baseline value, the controller 34 proceeds to a calibration step. The controller 34 is instructed at 130 to determine if the top brush 42 baseline value (BV) is greater than or equal to a predetermined calibration value (CV). The calibration value (CV) may be, for example, 90 rpm. This calibration step determines whether the top brush 42 is operating satisfactory. Thus, if the baseline value (BV) is less than the calibration value (CV), then it can be determined that the top brush 42 is not rotating at its normal rotational speed, and some repairs or other maintenance may need to be performed. The controller 34 may be programmed to send an error report at instruction 131 to the user or may be programmed to shut down the apparatus. Alternatively, the controller 34 may be programmed to send an error report to the user and store the occurrence of errors, whereby if the number of errors exceeds a predetermined value, then the controller is programmed to shut down the apparatus.

If the baseline value (BV) is greater than or equal to the calibration value (CV), then the controller 34 is instructed at 132 to subtract an adjustment value (AV) from the baseline value (BV) and is instructed at 133 to store the difference as a target value (TV). The target value (TV) is the desired rotational speed of the top brush 42 as it contacts the vehicle, which in effect, is proportional to the amount of contact between the cloth strands 44 and the vehicle. Thus, the predetermined adjustment value (AV) adjusts the baseline value (BV) to take into account the desired amount of contact between the cloth strands 44 and the vehicle. The adjustment value (AV) may be a set, predetermined value that is independent of the baseline value (BV), or the adjustment value may be some function (e.g., a percentage) of the baseline value that is calculated before each separate wash. As an example, the adjustment value (AV) may be 10 rpm. Accordingly, if the baseline value (BV) is 105 rpm, the target value (TV) would be 95 rpm.

Using the target value (TV), the controller 34 is instructed at 134 to subtract a first variance value (VV₁) from the target value (TV) and is instructed at 136 to store the difference as the lower threshold value (LTV) of the lift/lower range. The controller 34 is instructed at 138 to add a second variance value (VV₂) to the target value (TV) and is instructed at 140 to store the sum as the upper threshold value (UTV) of the lift/lower range.

The first and second variance values (VV₁, VV₂) are predetermined values that take into account an acceptable amount of variance of the rotational speed of the top brush 42 from the target value, whereby if the rotational speed is outside this variance, then the top brush must be lifted or lowered. As stated above, the top brush 42 usually needs to be lifted when it is moving along a portion of the vehicle that has a relatively small, inclined slope, and it usually needs to be lowered when it is moving along a portion of the vehicle that has a relatively small, declined slope.

The variance values (VV₁, VV₂) may be set, predetermined values that are independent of the target and baseline values (TV, BV), or the variance values may be some function (e.g., a percentage) of the target or baseline values that are calculated before each separate wash. For example, the first variance value (VV₁) may be 5 rpm and the second variance value (VV₂) may be 6 rpm. Thus, where, for example, the target value (TV) is 95 rpm, the lower threshold value (LTV) of the lift/lower range would be 90 rpm and the upper threshold value (UTV) of the lift/lower range would be 101 rpm. As stated above, the controller will lift or lower the top brush only if the rotational speed of the top brush 42 is either less than the lower threshold value (LTV) or greater than the upper value (UTV), respectively, of the lift/lower range.

The controller 34 is instructed at 142 to subtract a third variance value (VV₃) from the target value (TV) and is instructed at 144 to store the difference as the lower stop threshold value (LSTV) of the stop range. The controller 34 is also instructed at 146 to add a fourth variance value (VV₄) to the target value (TV) and is instructed at 148 to store the sum as the upper stop threshold value (USTV) of the stop range.

The third and fourth variance values (VV₃, VV₄) function to take into account the necessity of stopping the longitudinal movement of the top brush 42 when the top brush is moving along a portion of the vehicle that has a relatively large slope (either declined or inclined). Thus, the third variance value (VV₃) is typically greater than the first variance value (VV₁) and the fourth variance value (VV₄) is typically greater than the second variance value (VV₂), whereby the stop range encompasses the lift/lower range.

The variance values (VV₃, VV₄) may be fixed, predetermined values that are independent of the target and baseline values (TV, BV), or the variance values may be some function (e.g., a percentage) of the target or baseline values that are calculated before each separate wash. In one example, the third variance value (VV₃) is 7 rpm and the fourth variance value (VV₄) is 8 rpm. Thus, where the target value (TV) is 95 rpm, the lower stop threshold value (LSTV) would be 88 rpm and the upper stop threshold value (USTV) would be 103 rpm.

Other ways of calculating or determining the lift/lower range and the stop range are within the scope of this invention.

Referring now to FIGS. 1 and 14-17C, left and right wheel washing apparatus for cleaning wheels of the vehicle are generally indicated at 150L, 150R, respectively. As shown best in FIG. 1, each wheel washing apparatus 150L, 150R is mounted on a corresponding right and left leg 24L, 234R of the carriage 12. The wheel washing apparatus 150L, 150R are essentially identical in structure and operation; accordingly, for convenience and clarity, only the left wheel washing apparatus 150L will be referred to in detail herein.

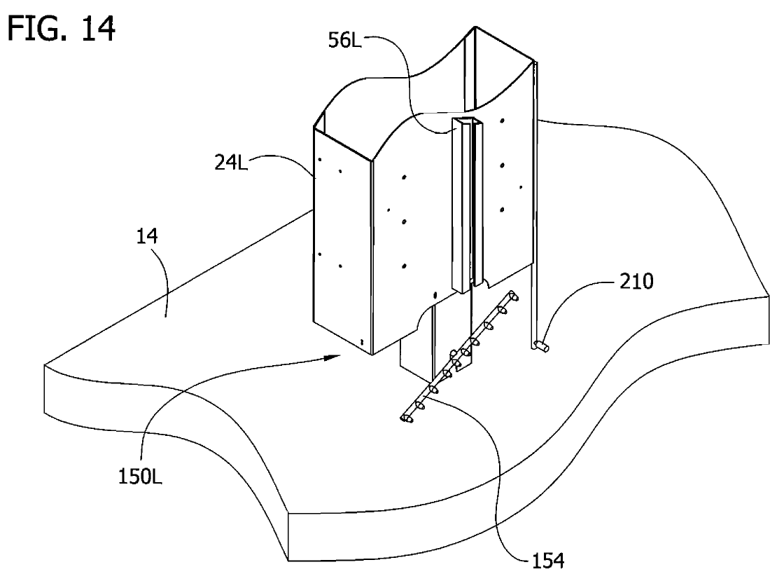

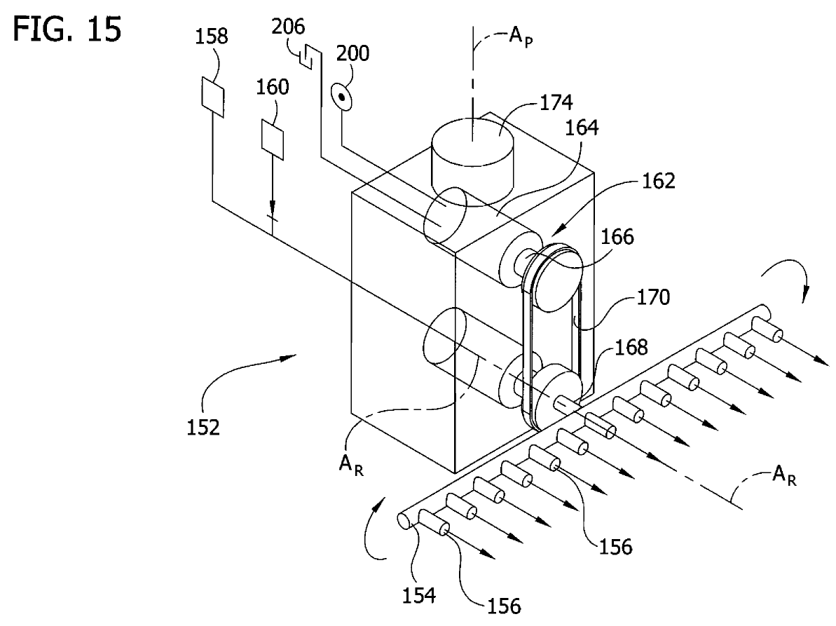

Referring to FIGS. 14 and 15, the wheel washing apparatus 150L comprises a spray device, generally indicated at 152, for applying treatment to the wheels of the vehicle. For example, the spray device 152 may be configured to apply a high pressure wash and rinse using water and may additionally be configured to apply a cleaning fluid, such as a detergent, to the wheels. The spray device 152 includes an elongate spray bar 154 having a plurality nozzles 156 disposed along its length LB. The spray bar 154 and associated nozzles 156 are fluidly connected to both a source of the high pressure fluid 158 and a source of the cleaning fluid 160 to direct such fluid to the wheels of the vehicle. As explained in more detail below, the wheel washing apparatus 150L may be configured to also apply treatment to a side of the vehicle, including a rocker panel.

The spray device 152 includes a rotational device 162 (FIG. 15) for rotating the spray bar 154 about a generally horizontal rotational axis A_{R}, such that the length LB of the spray bar rotates. In the illustrated embodiment, the rotational device 162 includes a rotation motor 164, such as a hydraulic or pneumatic motor, driving an output shaft 166. The output shaft 166 is connected to a bar shaft 168 via a belt 170. Rotation of the output shaft 166 imparts rotation of the spray bar 154. The structure and operation of such a motor 164 is well known in the art and will not be described in detail. Other ways of rotating the spray bar are within the scope of this invention.

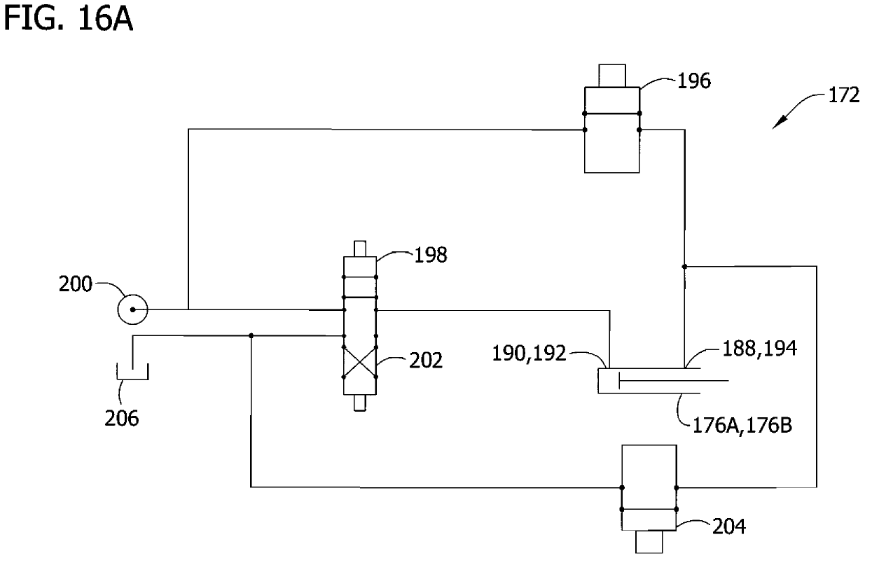

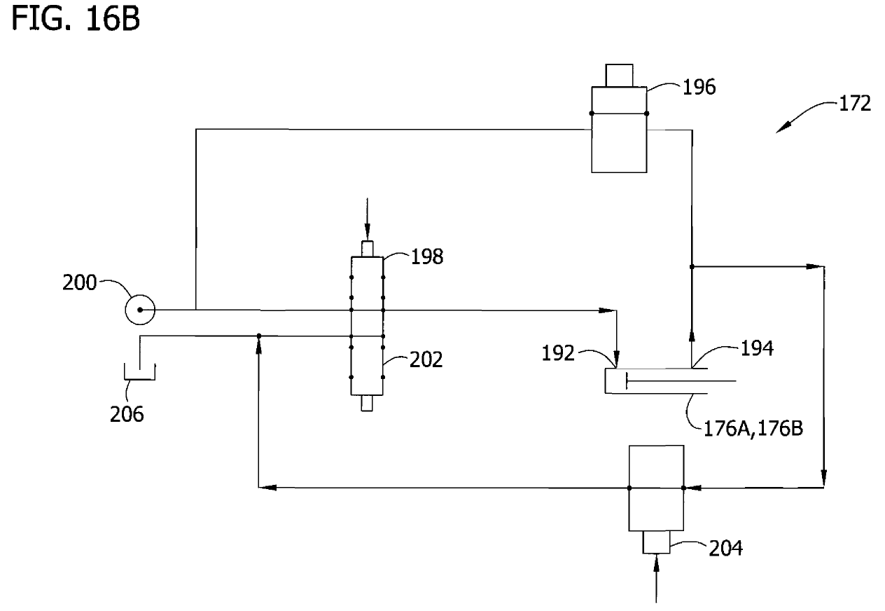

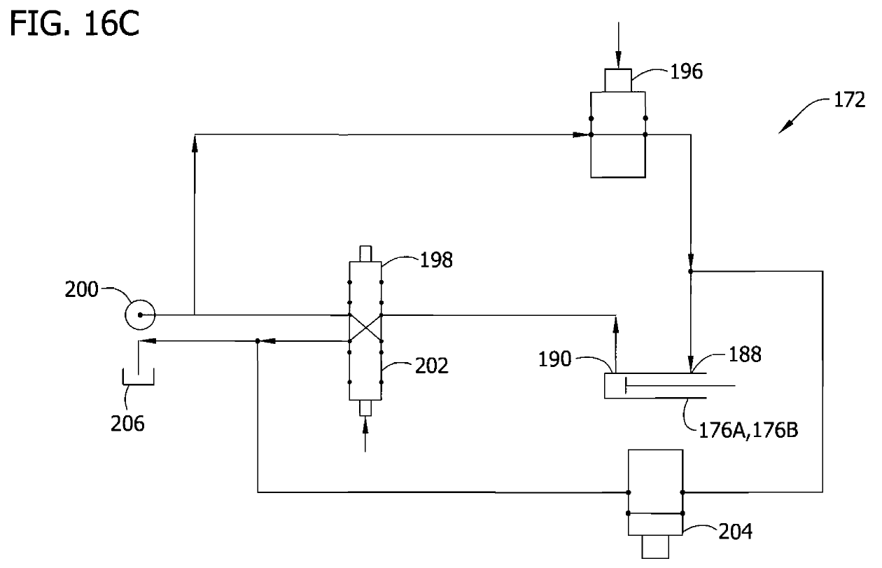

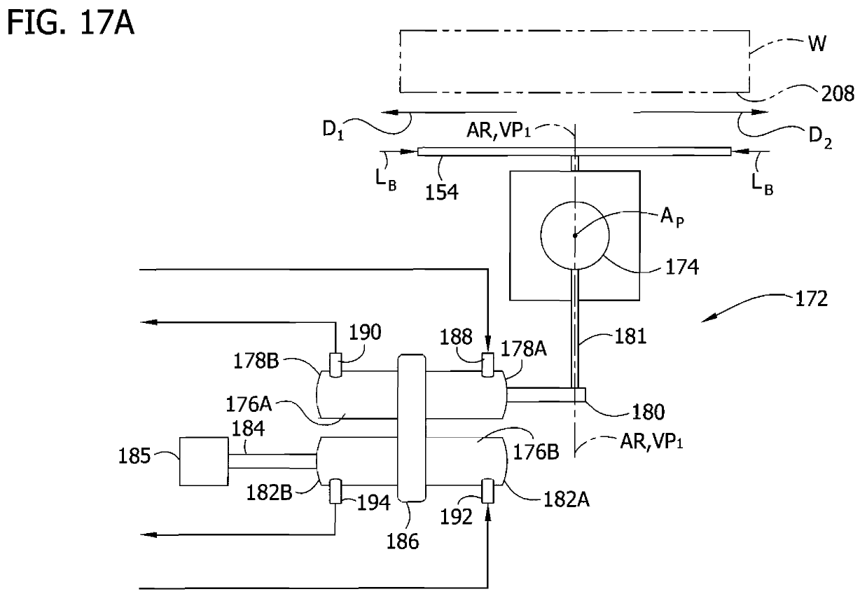

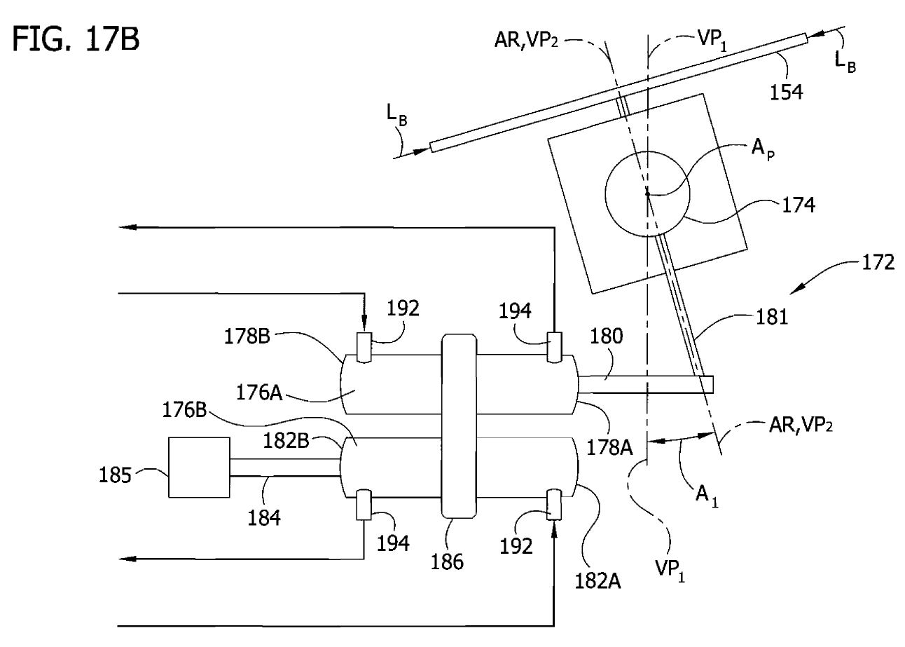

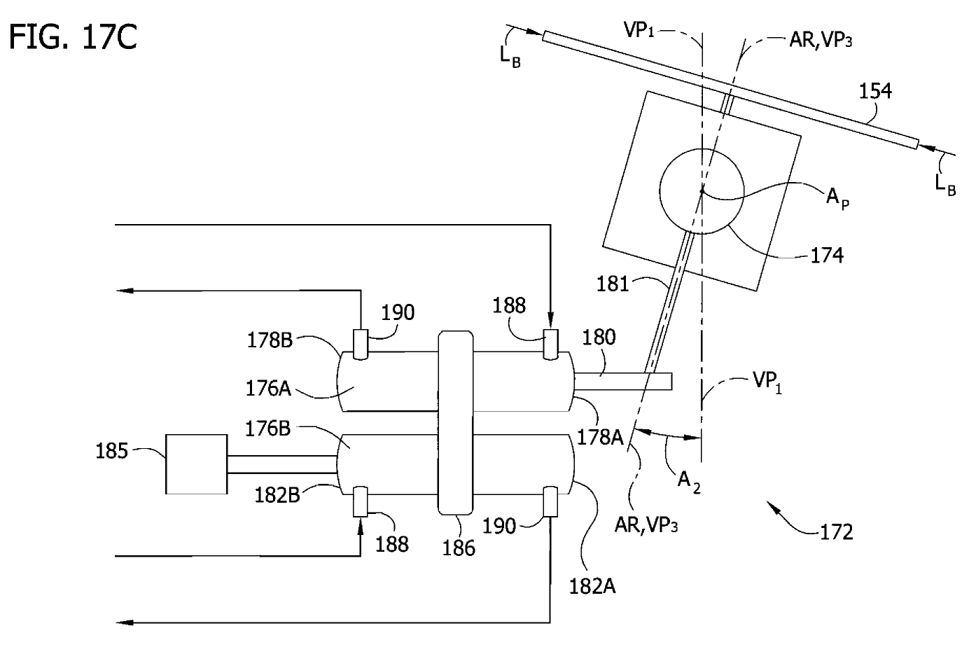

Referring to FIGS. 16A-17C, the wheel washing apparatus 150L also comprises a pivotal device 172 for pivoting the spray device 152 about a generally vertical pivotal axis A_{P}. The pivotal device 172 may be configured to pivot the spray device 152 about the pivotal axis A_{P} in first and second opposite directions D₁, D₂, respectively.

In one embodiment, the pivotal device 172 comprises a swivel 174 connected to the spray device 152 and first and second pivotal cylinders (e.g., air cylinders), generally indicated at 176A, 176B, respectively, for pivoting the spray device on the swivel (FIGS. 17A-17C). The pivotal axis A_{P} is in part defined by a pivot point of the swivel 174. The first pivotal cylinder 176A has opposite first and second ends 178A, 178B, respectively, and comprises a first rod 180 that is extendable out of the first end of the cylinder. The first rod 180 is pivotally connected to a swivel shaft 181 extending from the swivel 174. The second pivotal cylinder 176B has opposite first and second ends 182A, 182B, respectively, and comprises a second rod 184 that extends out of the second end of the second cylinder. The second rod 184 is secured to a fixed structure 185 on the carriage 12. The first and second cylinders 176A, 176B, respectively, are parallel and secured together using a collar 186 to prohibit movement relative to each other. Corresponding first ends 178A, 182A are generally adjacent and corresponding second ends 178B, 182B are generally adjacent. Thus, the respective rods 180, 184 of the pivotal cylinders 176A, 176B are extendable in opposite directions.

The illustrated cylinders 176A, 176B are dual-acting air cylinders. FIGS. 16A-16C schematically illustrate only one of the air cylinders 176A, 176B, with the understanding that the other cylinder acts in the same manner. Each cylinder 176A, 176B has a retract inlet 188, a retract outlet 190, an extend inlet 192 (corresponding to the retract outlet), and an extend outlet 194 (corresponding to the retract inlet). A retract inlet valve 196 and an extend inlet valve 198 (both of which may be solenoid valves) fluidly connect the respective retract and extend inlets 188, 192, respectively, to a source of pressurized air 200. A retract outlet valve 202 and an extend outlet valve 204 (both of which may be solenoid valves) fluidly connect the respective retract and extend outlets 190, 194, respectively, to a reserve tank 206.

As shown in FIG. 16B, when the extend inlet valve 198 and the extend outlet valve 204 are open and the retract inlet valve 196 and the retract outlet valve 202 are closed, pressurized air enters the extend inlet 192 and extends the rod 180, 184 of the cylinder 176A, 176B. Similarly, as illustrated schematically in FIG. 16C, when the extend inlet valve 198 and the extend outlet valve 204 are open and the retract inlet valve 196 and the retract outlet valve 202 are closed, pressurized air enters the retract inlet 188 and retracts the rod 180, 184 of the cylinder 176A, 176B. In the illustrated embodiment, actuations of the cylinders 176A, 176B are controlled by the controller 34. Other types of cylinders may be used within the scope of this invention.

Referring to FIGS. 17A-17C, the pivotal device 172 is arranged to operate in the following manner. To position the spray device 152 in a first position, the controller 34 fully retracts the first rod 180 (e.g., pressurizes the first cylinder 176A via the retract inlet 188) and fully extends the second rod 184 (e.g., pressurizes the second cylinder 176B via the extend inlet 192). In the first position, the rotational axis A_{R} of the spray bar 154 lies in an initial vertical plane VP₁ that is generally perpendicular to an outer face 208 of an adjacent wheel W, shown in phantom.

As illustrated in FIG. 17B, to move the spray device 152 in the first direction D₁ from the first position to a second position, the controller 34 retracts the second rod 184 (e.g., pressurizes the second cylinder 176B via the retract inlet 188), while maintaining retraction of the first rod 180. In the second position, the rotational axis A_{R} of the spray bar 154 lies in a second vertical plane VP₂ that is offset an angle A1 from the initial vertical plane VP₁. This angle A1 represents the degrees of rotation of the spray device between the first position and the second position. To move the spray device 152 back to its first position, the controller 34 extends the first rod 180, while maintaining retraction of the second rod 184.

As illustrated in FIG. 17C, to move the spray device 152 in the second direction D₂ from the first position to a third position, the controller 34 extends the first rod 180 (e.g., pressurizes the first cylinder 178A via the extend inlet 192), while maintaining extension of the first rod 180. In the third position, the rotational axis A_{R} of the spray bar 154 lies in a third vertical plane VP₃ that is offset an angle A2 from the initial vertical plane VP₁. This angle A2 represents the degrees of rotation of the spray device between the first position and the third position. The controller 34 retracts the first rod 180, while maintaining extension of the second rod 184 to move the spray device 152 back to its first position.

It is understood that the pivotal device 172 may comprise other ways of pivoting the spray device 152 besides the use of he two dual-acting cylinders 176A, 176B. For example, the pivotal device 172 may instead include a 3-position cylinder or rotary actuator, the structure and use of each are well known in the art. Other devices are within the scope of this invention.

The pivoting device 172 may be configured to pivot the spray device 152 such that the angles A1 and A2 are between about 10 degrees and about 60 degrees, thereby making the total range of motion of the spray device 152 between about 20 degrees and about 120 degrees. More specifically, the pivoting device 172 may be configured so that the angles A1 and A2 are between about 20 degrees and about 40 degrees, making the total range of motion of the spray device 152 between about 40 degrees and about 80 degrees. More specifically still, the angles A1 and A2 may be about 35 degrees, making the total range of motion of the spray device 152 about 70 degrees.

In one embodiment, the controller 34 is programmed to control the movement of the first and second rods 180, 184, respectively, to effectively oscillate the spray device 152 continuously through its full range of motion. That is, the spray device 152 may only stop briefly, if at all, at the first, second and third positions before the controller 34 actuates the next movement to effectively oscillate the spray device 152. Oscillating the spray device 152, particularly the spray bar 154 of the spray device, in this manner is effective in cleaning wheels and wheel wells of the vehicle. Instead of directing high pressure water, for example, at only a perpendicular angle with respect to the outer face 208 of the wheel, the water contacts the wheel at varying angles (e.g., anywhere between about 20 degrees and about 120 degrees). Moreover, angling the spray bar 154 with respect to the outer face 208 of the wheel allows cleaning fluid to directly contact the wheel well surface, which is difficult if not impossible to do if the cleaning fluid is contacting the outer face of the wheel and side of the vehicle only at a 90 degree angle.

As briefly stated above, the wheel washing apparatus 150L, 150R may also be configured to apply selective treatment to rocker panels and doors of the vehicle. In one embodiment, the apparatus 150L, 150R applies one type of treatment to the rocker panels and the doors of the vehicle and second, different type of treatment to the wheels of the vehicle. For example, the controller 34 may be programmed to only oscillate the spray device 152 when the spray device is adjacent a wheel of the vehicle. Moreover, the controller 34 may be programmed to apply specific wheel cleaner only to the wheels of the vehicle and not along the rocker panels and doors of the vehicle. Accordingly, to accurately apply separate treatments to the wheels and the side of the vehicle, the positions of the wheels are determined.

Referring back to FIG. 14, in one embodiment, the wheel washing apparatus 150L, 150R include a wheel detector 210, such as a proximity detector, adjacent the spray devices 152 and extending downward from the carriage 12 adjacent the floor 14. The wheel detector 210 detects the position of the wheels as the carriage 12 moves past the wheels. The detector 210 sends a position output signal to the controller 34 indicative of the position of the wheel, and the controller saves this data in its memory. Using the wheel position data, the controller 34 is able determine when the wheel washing apparatus 150L, 150R are adjacent wheels of the vehicle. Accordingly, the controller 34 is able to apply the selected treatments only to the wheels and/or to the sides of the vehicle.

An exemplary washing cycle of the wheel washing apparatus will now be described. A vehicle enters the car wash apparatus and stops in the treadle, thereby activating the apparatus. The carriage 12 moves longitudinally along the length of the car as the wheel detectors 210 detect the positions of the wheels of the vehicle. The positions of the wheels of the vehicle are stored in the controller's memory. The controller 34 actuates rotation of the spray bars 154 and application of high pressure water from the nozzles 156 to the sides of the vehicle at its rear end, for example. The carriage 12 move longitudinally towards the front of the vehicle. The controller 34 monitors the position of the carriage 12 and stops the carriage when the wheel washing apparatus 150L, 150R are adjacent the rear wheels. The controller 34 actuates application of a wheel cleaning fluid via the nozzles 156 of the spray bar 154 as the spray bar rotates at a decreased speed. After application of the cleaner, the controller 34 actuates longitudinal movement of the carriage 12 and application of high pressure water and high speed rotation of the spray bars 154 along the rocker panels until the wheel washing apparatus 150L, 150R are adjacent the front wheels. The controller 34 actuates application of wheel cleaning fluid to the front wheels, after which, the controller actuates longitudinal movement of the carriage 12 and application of high pressure water and high speed rotation of the spray bars along the side of the vehicle at its front end.

The controller 34 then actuates longitudinal movement of the carriage 12 toward the rear of the vehicle while apply the high pressure wash treatment. When the wheel washing apparatus are adjacent the front wheels, the controller 34 stops the carriage 12. The controller actuates high pressure fluid flow through the nozzles 156 of the spray bar 154. As the spray bars 154 are rotating at a high rate of speed and directing high pressure water through their nozzles 156, the controller 34 actuates oscillation of the spray device 152, as described above, to clean the front wheels and the front wheel wells. After oscillating the spray device 152 (e.g., for 2-5 cycles), the controller 34 actuates longitudinal movement of the carriage 12 toward the rear of the car, cleaning the rocker panels and doors of the vehicle with a high pressure wash, until the spray device 152 is adjacent the rear wheels, whereby the substantially the same treatment that was applied to the front wheels is applied to the rear wheels.

It is understood that the vehicle washing apparatus 10 may be simultaneously operating other components, such as the nozzles, the shower heads, the side brushes 30, and the top brush 42. It is also understood that the washing cycles of the wheel washing apparatus 150L, 150R may be other than the exemplary washing cycle described above without departing from the scope of this invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method of washing a vehicle, said method comprising
providing a spray apparatus including an elongate spray bar comprising a plurality of nozzles for directing liquid toward the vehicle, the spray bar being rotatable about a generally horizontal rotational axis,
disposing the spray bar of the spray apparatus adjacent a wheel of the vehicle such that the spray apparatus is in a first position,
rotating the spray bar about its rotational axis,
pivoting the spray apparatus about a generally vertical pivotal axis in a first direction from the first position to a second position,
directing fluid out of the nozzles towards the wheel of the vehicle.

2. The method set forth in claim 1 wherein as the spray apparatus pivots about the pivotal axis, the spray bar is continuously rotating about the horizontal axis and fluid is continuously being directed out of the nozzles towards the wheel of the vehicle.

3. The method set forth in claim 2 wherein the spray apparatus pivots between about 10 degrees and about 60 degrees about the vertical axis.

4. The method set forth in claim 3 wherein the spray apparatus pivots between about 20 degrees and about 40 degrees about the vertical axis.

5. The method set forth in claim 2 further comprising pivoting the spray apparatus about the pivotal axis in a second direction opposite the first direction from the first position to a third position.

6. The method set forth in claim 5 wherein the spray apparatus pivots between about 10 degrees and about 60 degrees from its first position to its second position and pivots between about 10 degrees and about 60 degrees from its first position to its third position.

7. The method set forth in claim 6 wherein the spray apparatus pivots between about 20 degrees and about 40 degrees from its first position to its second position and pivots between about 20 degrees and about 40 degrees from its first position to its third position.

8. The method set forth in claim 7 wherein the spray apparatus pivots about 35 degrees from its first position to its second position and pivots about 35 degrees from its first position to its third position.

9. The method set forth in claim 5 wherein the spray apparatus continuously oscillates between its second and third positions.

10. The method set forth in claim 1 further comprising
advancing the position of the spray apparatus relative to the length of the vehicle,
determining when the spray bar of the spray apparatus is adjacent the wheel,
discontinuing the advancement of the position of the spray apparatus relative to the length of the vehicle after it is determined that the spray bar is adjacent the wheel,
initiating oscillation of the spray apparatus only after it is determined that the spray bar is adjacent the wheel.

11. The method set forth in claim 10 further comprising discontinuing oscillation of the spray apparatus after a period of time, and continuing advancement of the position of the spray apparatus relative to the length of the vehicle until it is determined that the spray bar is adjacent another wheel of the vehicle.

12. A wheel washing apparatus for washing wheels of a vehicle, said apparatus comprising
a spray device including an elongate spray bar having nozzles disposed along its length bar for directing streams of fluid from the bar and a rotational device for rotating the spray bar about a generally horizontal rotational axis, and
a pivoting device for pivoting the spray device about a generally vertical pivotal axis in a first direction between a first position and a second position.

13. The apparatus set forth in claim 12 wherein the pivoting device is configured to pivot the spray device between about 60 degrees and about 20 degrees from the first position to the second position.

14. The apparatus set forth in claim 13 wherein the pivoting device is configured to pivot the spray device between about 40 degrees and about 30 degrees from the first position to the second position.

15. The apparatus set forth in claim 12 wherein the pivoting device comprises a first cylinder having a first piston extendable in a first direction and retractable in a second, opposite direction, said first piston being connected to the spray device such that extension and retraction of the piston actuates pivoting of the spray device about the pivotal axis.

16. The apparatus set forth in claim 12 wherein the pivoting device is also configured to pivot the spray device about the vertical axis in a second, opposite direction between the first position and a third position.

17. The apparatus set forth in claim 16 wherein the pivoting device comprises
a first cylinder having a first piston extendable in a first direction and retractable in a second, opposite direction, the first piston being connected to the spray device,
a second cylinder having a second piston extendable in the second direction and retractable in the second direction, the second piston being secured to a stationary structure,
wherein the first and second cylinders parallel and secure together, such that the spray device is in its first position when the first piston is extended and the second piston is retracted, the spray device is in its second position when both the first and the second pistons are retracted, and the spray device is in its third position when both the first and the second pistons are extended.

18. The apparatus set forth in claim 17 wherein the pivoting device is configured to oscillate the spraying apparatus between its first, second and third positions.

19. The apparatus set forth in claim 16 wherein the pivoting device is configured to pivot the spray device between about 60 degrees and about 20 degrees from the first position to the second position and between about 60 degrees and about 20 degrees from the first position to the third position.

20. The apparatus set forth in claim 13 wherein the pivoting device is configured to pivot the spray device between about 40 degrees and about 30 degrees from the first position to the second position and between about 40 and about 30 degrees from the first position to the third position.

21. A method of washing wheels of a vehicle, comprising
advancing the spray bar along the length of the vehicle,
applying a treatment of a first type to a side of the vehicle as the spray bar advances along the length of the vehicle,
temporarily stopping the advancement of the spray bar along the length of the vehicle at a first wheel,
applying a treatment of a second, different type to the wheel of the vehicle using the same spray bar when the advancement of the spray bar has been stopped,
continuing advancement of the spray bar along the length of the vehicle after application of the treatment to the wheel.
